(19) United States
(12) Patent Application Publication
(10) Pub. No.: US 2023/0359921 A1
(43) Pub. Date: Nov. 9, 2023

(54) INFORMATION PROCESSING SYSTEM, INFORMATION PROCESSING DEVICE, INFORMATION PROCESSING METHOD, AND RECORDING MEDIUM

(71) Applicant: NEC Corporation, Minato-ku, Tokyo (JP)

(72) Inventors: Takahiro NISHIMURA, Tokyo (JP); Hiroaki INOUE, Tokyo (JP); Takuya ARAKI, Tokyo (JP); Motoi SUZUKI, Tokyo (JP); Fumiyo TAKANO, Tokyo (JP); Yuki KOBAYASHI, Tokyo (JP); Hiroshi CHISHIMA, Tokyo (JP); Akihiro YATABE, Tokyo (JP)

(73) Assignee: NEC Corporation, Minato-ku, Tokyo (JP)

(21) Appl. No.: 18/026,056

(22) PCT Filed: Aug. 31, 2021
(86) PCT No.: PCT/JP2021/031966

§ 371 Date: Mar. 13, 2023

(30) Foreign Application Priority Data
Sep. 23, 2020 (JP) 2020-159139

(51) Int. Cl. G06N 10/60; G06F 17/11

(52) U.S. Cl. CPC G06N 10/60; G06F 17/11

(57) ABSTRACT

An information processing device that compares a data amount of a QUBO model to be processed by an annealing engine and a data amount of a program representing the QUBO model, and that transmits whichever has a lower data amount to the annealing engine.

### TECHNICAL FIELD

The present invention relates to an information processing device, etc. communicating over a communication network.

### BACKGROUND ART

As indicated in Patent Document 1, cloud services that use annealing are provided.

### CITATION LIST

### Patent Literature

### [Patent Document 1] Japanese Unexamined Patent Application, First Publication No. 2020-042687

### SUMMARY OF THE INVENTION

### Problems to be Solved by the Invention

However, when using the cloud service disclosed in Patent Document 1, as the scale of a problem becomes larger, the data amount of model data quickly becomes enormous. As a result thereof, in said cloud service, the communication time required for communicating said data becomes long, making it difficult to receive provided services within a practical time period.

Therefore, an example objective of the present invention is to provide an information processing device, etc. that can receive provided services within a practical time period.

### Means for Solving the Problems

As an example of one aspect of the present invention, an information processing device has data format determining means for comparing a data amount of a QUBO model to be processed by an annealing engine and a data amount of a program representing the QUBO model, and transmitting whichever has a lower data amount to the annealing engine.

Additionally, as an example of another aspect of the present invention, an information processing method includes comparing a data amount of a QUBO model to be processed by an annealing engine and a data amount of a program representing the QUBO model, and transmitting whichever has a lower data amount to the annealing engine.

Additionally, as an example of another aspect of the present invention, an information processing program makes a computer implement a function for comparing a data amount of a QUBO model to be processed by an annealing engine and a data amount of a program representing the QUBO model, and a function for transmitting whichever has a lower data amount to the annealing engine. Furthermore, said objective is realized by a computer-readable recording medium in which the program is recorded.

### Advantageous Effects of Invention

According to the information processing device, etc. of the present invention, provided services can be received within a practical time period.

### BRIEF DESCRIPTION OF THE DRAWINGS

FIG. 1 is a block diagram depicting the configuration of an information processing system according to a first embodiment of the present invention.

FIG. 2 is a flow chart depicting a summary of processes in the information processing system according to the first embodiment.

FIG. 3 is a diagram conceptually depicting an example of the traveling salesman problem.

FIG. 4 is a diagram conceptually depicting an example of spin in the traveling salesman problem.

FIG. 5 is a diagram conceptually depicting an example of a program representing a process for computing a Hamiltonian.

FIG. 6 is a diagram conceptually depicting an example of a QUBO model represented in matrix form.

FIG. 7 is a flow chart depicting the flow of processes in an information processing device (local machine) according to the first embodiment.

FIG. 8 is a flow chart depicting the flow of processes in a server according to the first embodiment.

FIG. 9 is a block diagram depicting the configuration of an information processing device according to a second embodiment of the present invention.

FIG. 10 is a flow chart depicting the flow of processes in the information processing device according to the second embodiment.

FIG. 11 is a block diagram schematically depicting an example of the hardware configuration of a computational processing device by which an information processing system, an information processing device, and a server can be realized according to respective embodiments of the present invention.

### EXAMPLE EMBODIMENT

Next, embodiments for implementing the present invention will be explained in detail with reference to the drawings.

### First Embodiment

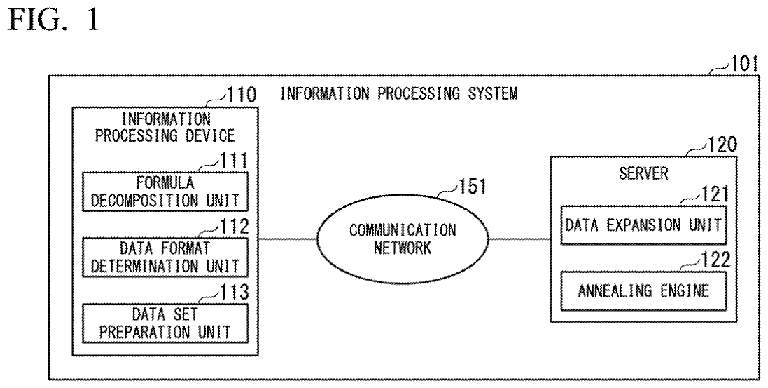

The configuration of the information processing system 101 according to the first embodiment of the present invention will be described in detail with reference to FIG. 1. FIG. 1 is a block diagram depicting the configuration of the information processing system 101 according to a first embodiment of the present invention.

The information processing system 101 according to the first embodiment has an information processing device 110, a communication network 151, and a server 120. The information processing device 110 and the server 120 are communicably connected over a communication network 151. The information processing device 110 and the server 120 may be connected by a transmission line.

The information processing device 110 has a formula decomposition unit 111, a data format determination unit 112, and a data set preparation unit 113. Hereinafter, the information processing device 110 will also be referred to as a “local machine” for convenience of explanation.

The server 120 has a data expansion unit 121 and an annealing engine 122.

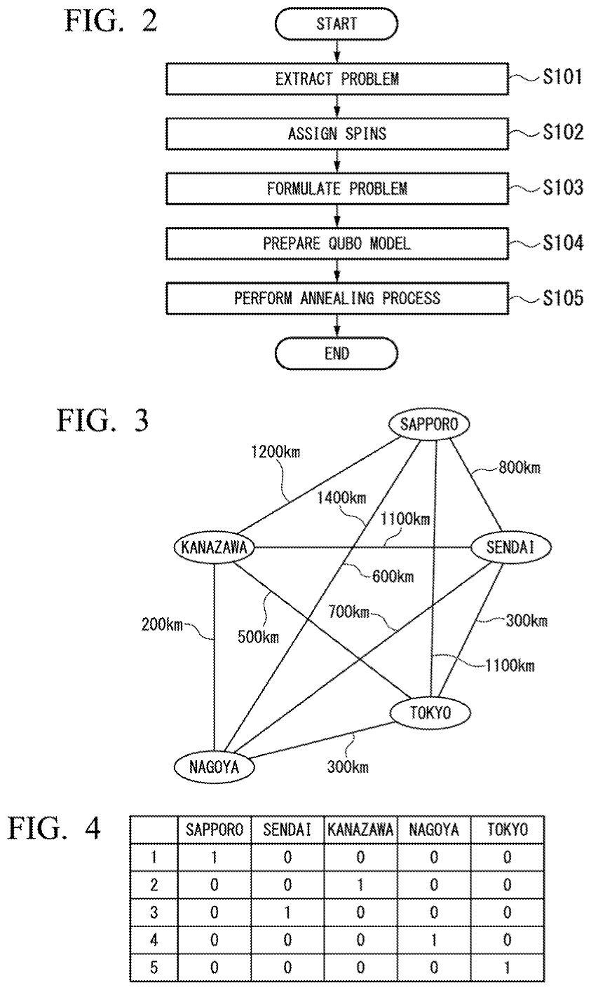

The server 120 can provide services for outputting solutions to combinatorial optimization problems based on a minimum energy search calculation method. In this case, the information processing system 101 that provides services to the information processing device 110 can be realized by processes as indicated in FIG. 2. FIG. 2 is a flow chart depicting a summary of the processes in the information processing system 101 according to the first embodiment.

The processes in the information processing system 101 are, broadly speaking, realized by sequentially executing the processes from step S101 to step S105 indicated in FIG. 2.

(Step S101) A process for extracting a problem that is to be calculated (hereinafter referred to as “extraction process 1”). Extraction process 1 determines whether or not a given problem includes a combinatorial optimization problem, and in the case in which the given problem does include a combinatorial optimization problem, it can be considered to be a process for extracting the combinatorial optimization problem from the given problem.

(Step S102) A process for representing the extracted problem using parameters representing spins (process for assigning parameters representing spins) (hereinafter referred to as “spin assignment process 2”). The spin assignment process 2 can also be considered to be a process for using spins to represent the extracted combinatorial optimization problem.

(Step S103) A process for formulating the problem using the assigned spins (hereinafter referred to as “formulation process 3”).

(Step S104) A process for representing the formulated expression as a QUBO (abbreviation for “Quadratic unconstrained binary optimization”) model (process for preparing a QUBO model) (hereinafter referred to as “model preparation process 4”).

(Step S105) A process for determining a solution by annealing in accordance with the prepared QUBO model (hereinafter referred to as “annealing process 5”). Said process can also be considered to be an annealing operation and in the case of realization by using a quantum chip.

Hereinafter, the parameters representing the spins will be referred to simply as “spins” for convenience of explanation.

Next, the formula decomposition unit 111, the data format determination unit 112, and the data set preparation unit 113 will be explained. The information processing system 101 according to the present embodiment, for example, executes the processes indicated below between the processes from the formulation process 3 to the model preparation process 4.

A source program (hereinafter referred to as “source program S”) describing a process using annealing calculations is input to the formula decomposition unit 111. The source program S is written by using, for example, pyqubo, sympy, etc. Pyqubo refers to a preparatory library for preparing QUBOs. Sympy refers to an algebraic calculation library written in Python.

The formula decomposition unit 111 analyzes the input source program S, and extracts, from the source program S, processes relating to Hamiltonians (to be described below with reference to Expression 1, Expression 2, etc.). The processes relating to the Hamiltonians can be written, conceptually, as indicated in Expression 1 and Expression 2 (presented below).

Hereinafter, the processes relating to Hamiltonians in the source program S will be explained by using mathematical expressions representing the Hamiltonians for convenience of explanation.

The formula decomposition unit 111 determines whether or not the mathematical expressions can be simplified by mathematical formula manipulation. The formula decomposition unit 111 determines whether or not the mathematical expressions can be converted to mathematical expressions in which the data amount is decreased, for example, by factorizing the mathematical expressions.

Alternatively, the formula decomposition unit 111 may, for example, determine whether or not auxiliary spins (second spins) are used in the source program S. Auxiliary spins refer to spins that are introduced so that, for example, the product of three or more spins becomes the product of two or fewer spins. Auxiliary spins can also be considered to refer to spins that are defined by using the product of multiple spins. The formula decomposition unit 111 may, for example, in the case in which the source program S includes a command (or a rule) for defining auxiliary spins, be determined by using said command (or rule). This process will be explained in detail in Example 2 described below, with reference to Expression 6 to Expression 8, etc.

In the case in which a Hamiltonian includes auxiliary spins, the formula decomposition unit 111 prepares a Hamiltonian that is equivalent to said Hamiltonian without including the auxiliary spins (or having fewer auxiliary spins than the Hamiltonian that was input). Said process is, for example, realized by executing a process similar to the process for eliminating variables (parameters) in mathematics. In this case, the prepared Hamiltonian includes product of three or more spins. Since the data amount of a program not including auxiliary spins is smaller than the data amount of a program including auxiliary spins, said process provides the effect of allowing the data amount of the program to be reduced.

For the abovementioned process, a process performed on Hamiltonians was explained. However, a process similar to the above-mentioned process may be executed on programs representing processes similar to said Hamiltonians.

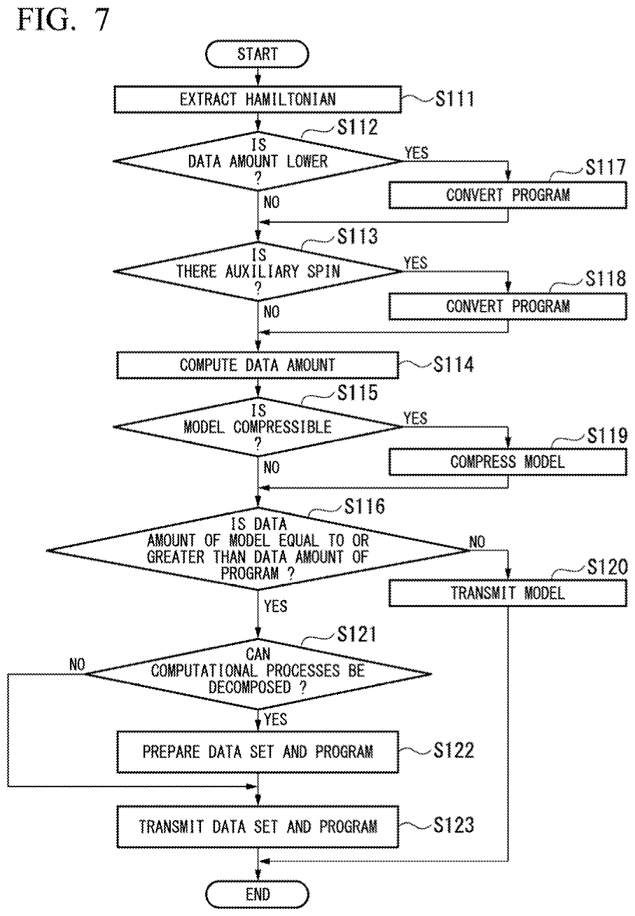

The data format determination unit 112 determines whether or not the data amounts of matrices in Ising and QUBO models representing the processes in the source program S are compressible. For example, the data format determination unit 112 determines that the data amount is compressible if it is determined that a matrix is sparse. The determination of whether or not a matrix is sparse is made, for example, according to whether or not the matrix satisfies determination criteria for determining that the number of non-zero elements among the elements in a matrix is small. That is, the determination criteria are criteria for determining that a matrix is compressible. The determination criteria will be explained below with reference to FIG. 7.

The data format determination unit 112 computes the data amount of a matrix after compression. The data format determination unit 112 compares the computed data amount with a data amount computed by the formula decomposition unit 111, and selects the data with the lower data amount.

The data format determination unit 112 transmits the data with the lower data amount to the server 120.

In the server 120, the data expansion unit 121 receives, from a local machine, a program (for example, program R) or a matrix in a QUBO model. When a program has been received from the local machine, the data expansion unit 121 prepares Ising and QUBO models in accordance with the received program. The data expansion unit 121 outputs the prepared Ising and QUBO models to the annealing engine 122. When Ising and QUBO models have been received from the local machine, the data expansion unit 121 outputs the prepared Ising and QUBO models to the annealing engine 122.

The annealing engine 122 receives the Ising and QUBO models as input, and computes solutions to the input Ising and QUBO models.

Hereinafter, the processes in the information processing system 101 according to the present embodiment will be explained with reference to the traveling salesman problem and the shift optimization problem.

### Example 1: Traveling Salesman Problem

An example of the traveling salesman problem will be explained with reference to FIG. 3. FIG. 3 is a diagram conceptually depicting an example of the traveling salesman problem.

The traveling salesman problem indicated in FIG. 3 is a problem of searching for the route with the shortest travel distance when wishing to visit five cities, each city being visited once. In FIG. 3, the five cities are Sapporo, Kanazawa, Sendai, Nagoya, and Tokyo. The traveling salesman problem is a combinatorial optimization problem in which the number of combinations of cities increases exponentially as the number of cities increases.

The places that are visited need not be cities, and for example, may be stations, factories, taxi stands, package collection areas, houses, etc. The places that are visited are not limited to the examples mentioned above. Hereinafter, the places that are visited may be referred to, more generally, as “nodes”.

### Spin Assignment Step 2 in Example 1

In the case of the traveling salesman problem indicated in FIG. 3, for example, spin is assigned as indicated in FIG. 4. FIG. 4 is a diagram conceptually depicting an example of spin in the traveling salesman problem.

Spin is, for example, expressed in matrix form. The form in which spin is expressed is not limited to the matrix form. The rows in the matrix represent the order of visitation. The columns in the matrix represent the respective cities. In this example, the spins are represented by using a (5×5) matrix. That is, the number of spins is 25.

If the value of a spin is 1, then this indicates that the relevant city is to be visited in the relevant order. If the value of a spin is 0, then this indicates that the relevant city is not to be visited in the relevant order. For example, the value of the element (3, 2) is 1. This indicates that Sendai (corresponding to the second column) is to be visited third (corresponding to the third row). For example, the value of the element (4, 4) is 1. This indicates that Nagoya (corresponding to the fourth column) is to be visited fourth (corresponding to the fourth row). For example, the value of the element (1, 3) is 0. This indicates that Kanazawa (corresponding to the third column) is not to be visited first (corresponding to the first row). That is, when the city j is to be the i-th visited, then the value of the spin X_{i,j} (corresponding to the element (i, j)) is 1. When the city j is not to be the i-th visited, then the value of the spin X_{i,j} (corresponding to the element (i, j)) is 0.

### Formulation Process 3 in Example 1

The distance between the city p1 and the city p2 is represented by Dₚ₁ₚ₂. The travel distances corresponding respectively to the above-mentioned five cities (from city 0 to city 4) are represented by the Hamiltonian H1 indicated by Expression 1.

H1=Σ_{J=0}⁴(Σ_{p1,p2=0}⁴Dₚ₁ₚ₂Xₚ₁ⱼXₚ₂₍ⱼ₊₁₎) (Expression 1)

In this case, Dₚ₁ₚ₂ represents the distance between city p1 and city p2. The Σ represents an operator for computing a sum. Expression 1 represents the process of summing, over city 0 to city 4, the total distance traveled, when visiting the city (j+1) from the city j, while visiting the other three cities.

The traveling salesman problem has the two constraints indicated below as constraint 1 and constraint 2.

(Constraint 1) Each city is visited only once. In other words, among the five spins representing the order of visitation of each city (a single column in the matrix indicated in FIG. 4), the value is 1 for only a single element corresponding to a row representing a single order (i.e., a single element in a single column), and the values of the remaining elements are 0.
(Constraint 2) Additionally, in the traveling salesman problem, the number of cities that can be visited at one time is just a single city. That is, among the five spins representing the order (a single row in the matrix indicated in FIG. 4), the value is 1 for only an element corresponding to a column representing a single city (i.e., a single element in a single row), and the values of the remaining elements are 0.

A Hamiltonian H2 for constraint 1 and constraint 2 can be represented by using Expression 2 below.

H2=Σⱼ₌₀⁴(Σᵢ₌₀⁴Xᵢⱼ−1)²+Σᵢ₌₀⁴(Σⱼ₌₀⁴Xᵢⱼ−1)² (Equation 2)

On the right side of Expression 2, the first term represents a process relating to constraint 1. On the right side of Expression 2, the second term represents a process relating to constraint 2.

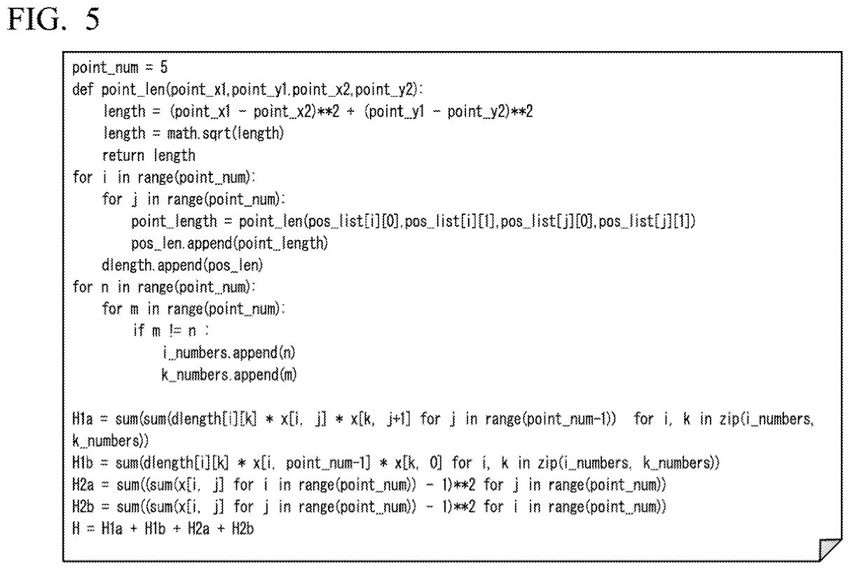

A program representing a process for computing a Hamiltonian in the traveling salesman problem, etc. will be explained with reference to FIG. 5. FIG. 5 is a diagram conceptually depicting an example of a program representing a process for computing a Hamiltonian.

The parameter H indicated on the last line in FIG. 5 represents a Hamiltonian. The parameters H1a, H1b, H2a, and H2b are parameters used for visibility. Sum represents a process for computing a summation value. The parameter dlength[i] [k] is a parameter representing the distance between city i and city k. The parameter pos_list is position information representing the location of a city. The parameter x represents spin.

The processes before the line including the parameter H1a represent processes for computing the distances between any two cities from information representing the locations of the cities. The processes on and after the line including the parameter H1a represent processes for computing the Hamiltonian.

The program is not limited to the example indicated in FIG. 5, and for example, may be a program for computing a Hamiltonian with the distances between the respective cities as inputs. Alternatively, the program may be a program as explained in Example 2 described below.

### Model Preparation Process 4 in Example 1

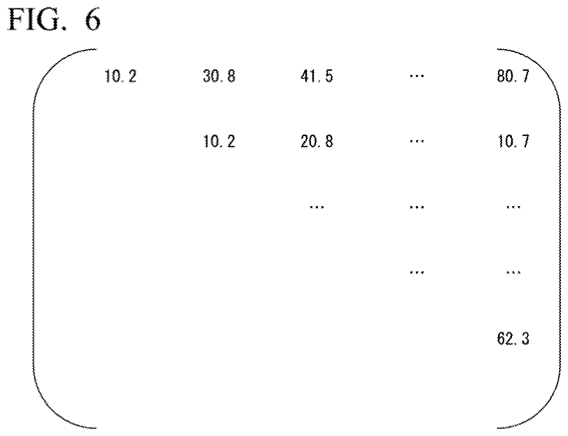

A QUBO model will be explained with reference to FIG. 6. FIG. 6 is a diagram conceptually depicting an example of a QUBO model in matrix form.

A QUBO model can be expressed in (N×N) matrix form having N rows and N columns (N being a natural number). The rows and columns represent cities. In the example of a matrix indicated in FIG. 6, N cities are represented. The respective elements in the rows and the respective elements in the columns both correspond to respective cities. Furthermore, the value of the element (element (I, J)) in row I, column J (I and J being natural numbers) represents a value computed in accordance with Hamiltonians (indicated in Expression 1 and Expression 2). For example, the value of element (I, J) represents a value obtained by adding the value of Expression 1 to the value of Expression 2, or a value obtained by weighting the value of Expression 1 and the value of Expression 2, and adding the weighted values. In this case, sine the value of element (I, J) is equal to the value of element (J, I), the matrix representing the QUBO model is symmetrical. For convenience, in FIG. 6, only the values of elements (I, J) where “I<J” are indicated. The matrix is not limited to the example mentioned above.

When transmitting a matrix representing a QUBO model to the server 120, the local machine transmits the values of all elemental components in an (N×N) upper triangular matrix to the server 120. That is, the local machine transmits N-squared order data to the server 120. Meanwhile, when the local machine transmits a program (as indicated in FIG. 5) representing processes equivalent to a QUBO model to the server 120, there is a possibility that a data amount is smaller than N-squared order data.

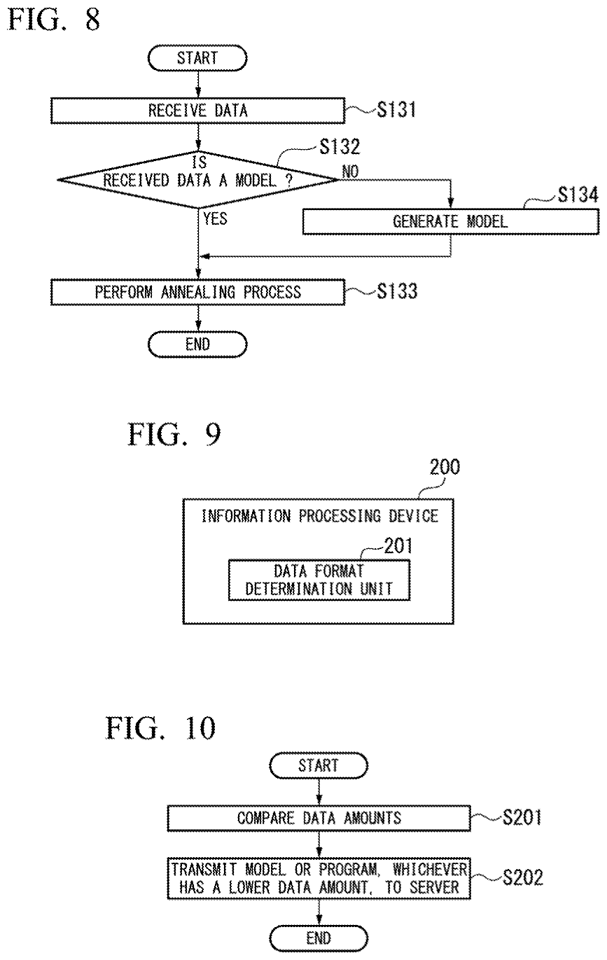

The processes in the information processing system 101 according to the first embodiment will be explained with reference to FIG. 7 and FIG. 8. FIG. 7 is a flow chart depicting the flow of processes in an information processing device 110 (local machine) according to the first embodiment. FIG. 8 is a flow chart depicting the flow of processes in the server 120 according to the first embodiment.

The formula decomposition unit 111 analyzes a source program S describing the processes for Hamiltonians, and extracts the processes representing the Hamiltonians (indicated in Expression 1 and Expression 2) (step S111). The formula decomposition unit 111 determines whether or not the extracted mathematical expressions can be converted to more simple mathematical expressions by mathematical formula manipulation. In other words, the formula decomposition unit 111 determines whether or not the extracted mathematical expressions can be converted to mathematical expressions having lower data amounts by mathematical formula manipulation (step S112).

For example, suppose that an extracted mathematical expression is the Hamiltonian (mathematical expression) represented by Expression 2. In this case, taking note of the case in which, of two bits, one will be 1, Expression 2 can be converted to Expression 3 below.

H2=(X[0, 0]+X[0, 1]−1)**2+(X[0, 0]+X[1, 0]−1)**2+(X[0, 1]+X[1, 1]−1)**2+(X[1, 0]+X[1, 1]−1)**2 (Expression 3)

In this case, “**2” represents an operator for a squaring.

By expanding Expression 3, and further applying the condition that, in a QUBO model, the square of a quantum bit (i.e., the parameter representing spin) is equal to the value of the quantum bit itself (for example, X[0, 0]**2=X[0, 0], X[1, 0]**2=X[1, 0], etc.), Expression 3 can be converted to Expression 4 below.

H2=2*X[0, 0]*X[0, 1]+2*X[0, 0]*X[1, 0]−2*X[0, 0]+2*X[0, 1]*X[1, 1]−2*X[0, 1]+2*X[1, 0]*X[1, 1]−2*X[1, 0]−2*X[1, 1]+4 (Expression 4)

In this case, “*” represents an operator for multiplication.

Therefore, by using the condition that the value of a square of a quantum bit (i.e., a parameter representing spin) is equal to the value of the quantum bit itself, the number of multiplications can be reduced by converting squares of the quantum bits to those quantum bits. That is, according to said process, the data amount becomes smaller by the decrease in the number of operations. Thus, the effect of being able to reduce the communication amount for communication between the local machine and the server 120 is obtained.

Then, by further applying a factorization process, Expression 4 can be converted to Expression 5 below.

H2=2*(X[0, 0]+X[1, 1]−1)*(X[0, 1]+X[1, 0]−1)+2 (Expression 5)

The Hamiltonian indicated by Expression 5 has a smaller data amount than the Hamiltonian indicated by Expression 2. Thus, the formula decomposition unit 111 determines that the source program S can be converted to a program using a simpler mathematical expression (YES in step S112). In the case of a YES in step S112, the formula decomposition unit 111 converts the source program S to a program using a more simplified Hamiltonian (step S117).

The converted program has a form similar to the program indicated in FIG. 5. However, the data amount of the converted program is smaller than the data amount of the source program S. Therefore, according to the above-mentioned processes in the formula decomposition unit 111, the data amount of the converted program is reduced from the data amount of the source program S. Thus, the effect of being able to reduce the communication amount for communication between the local machine and the server 120 is obtained.

In step S112, the formula decomposition unit 111 may determine whether or not, in the source program S, the process of computing the Hamiltonian is described by a loop process (iterative process, repetitive process). In the case in which said process is described by a loop process (YES in step S112), the formula decomposition unit 111 converts the loop process to a program representing a similar process using a sum function (step S117). In other words, in the case in which the process for computing the Hamiltonian is an iterative process of computing a sum by means of iterative processing, the formula decomposition unit 111 converts the iterative process to a function for computing the sum.

Alternatively, in the case in which a function representing a process equivalent to a loop process is defined, the formula decomposition unit 111 may convert the loop process to that function. In other words, in the case in which a process for computing a Hamiltonian is described by an iterative process in the program, the formula decomposition unit 111 may convert the iterative process to a function representing a process equivalent to the iterative process. The loop process is not limited to a process for computing a sum.

In this case, by rewriting a loop process to be a process of using a function for executing a process equivalent to the loop process, the data amount of the program is reduced. Therefore, according to a process as described above, the effect of being able to reduce the communication amount for communication between the local machine and the server 120 is obtained.

In the case of a NO in step S112, the formula decomposition unit 111 does not execute the process indicated by step S117.

The formula decomposition unit 111 determines whether or not a program (for example, the program R or the source program S) is a program that uses auxiliary spins (step S113). Step S113 and step S118 will be explained in Example 2 below.

The formula decomposition unit 111 computes the data amount of the program prepared in step S117 (step S114).

The data format determination unit 112 determines whether or not a matrix representing a QUBO model (indicated in FIG. 6) can be compressed (step S115). The data format determination unit 112 determines that a matrix can be compressed when, for example, the number of elements in the matrix for which the value of the elements are non-zero is less than the number of elements that are zero (YES in step S115).

The determination process is executed, for example, in accordance with whether or not the percentage of the number of non-zero elements relative to the number of elements contained in the matrix satisfies a prescribed determination criterion. The prescribed determination criterion is a criterion for determining whether to execute a compression process on the matrix. For example, the criterion may be that the percentage of the number of non-zero elements relative to the overall number of elements is 50%, 30%, or 10% or less. The prescribed determination criterion is not limited to the above-mentioned examples.

The traveling salesman problem is not necessarily a fully connected problem in which it is possible to travel between any two cities. For example, it may be a problem in which only routes on which it is possible to travel between cities are connected. The number of routes is, for example, a few percent of the fully connected number. In this case, the majority of the elements among the elements in the matrix representing the QUBO model (indicated in FIG. 6) have the value 0.

In the case of a YES in step S115, the data format determination unit 112 converts the matrix representing the QUBO model (indicated in FIG. 6) to information written in a prescribed compression format (step S119). The prescribed compression format may, for example, be a run length encoding format or a CRS (Compress Row sparse) format. The run length encoding format is a format whereby code sequence data in which the same symbol occurs consecutively is represented by using a single symbol and a symbol representing the length of the text string in which that one symbol consecutively occurs. The CRS format is a format for representing a matrix by using, in each row, a column number representing a non-zero element and the value of that element. The prescribed compression format is not limited to the above-mentioned examples. The data format determination unit 112 computes the data amount of the information after compression.

According to the above-mentioned compression process, the data amount of the matrix after compression is reduced in comparison with the matrix before compression. Thus, the effect of being able to reduce the communication amount for communication between the local machine and the server 120 is obtained.

Furthermore, the data format determination unit 112 compares the data amount computed in step S114 with the data amount computed in step S119 (step S116). In other words, the data format determination unit 112 compares the data amount of a QUBO model that is to be processed by the annealing engine 122 with the data amount of a program representing the QUBO model (i.e., the program R or the source program S).

In the case in which the data amount computed in step S119 is less than the data amount computed in step S114 (NO in step S116), the data format determination unit 112 transmits the QUBO model to the server 120 (step S120).

In the case in which the data amount computed in step S119 is equal to or greater than the data amount computed in step S114 (YES in step S116), the data set preparation unit 113 determines whether or not the calculation processes for the program representing the QUBO model, as in FIG. 6, can be decomposed (step S121).

Alternatively, the data set preparation unit 113 may transmit a program to the server 120. In this case, the data set preparation unit 113 compares the data amount of the QUBO model that is to be processed by the annealing engine 122 with the data amount of the program representing the QUBO model, and can transmit the one with the smaller data amount to the annealing engine 122.

In step S121, for example, if the data for the distance dlength[i] [k] between cities in FIG. 5 can be decomposed to data for (x, y) coordinates representing the locations of the respective cities, then the data set preparation unit 113 determines that the calculation process can be decomposed.

In the case that it is determined that the calculation process can be decomposed (YES in step S121), the data set preparation unit 113 prepares a data set including data expressing the (x, y) coordinates representing the locations of the respective cities and a program for calculating the distance dlength[i] [k] (step S122), and transmits the prepared data set and program to the server 120 (step S123).

In the case in which it is determined that the calculation process cannot be decomposed (NO in step S121), the process in step S122 is not executed.

In the case of the traveling salesman problem, Dₚ₁ₚ₂ in the Hamiltonian H1 (indicated in Expression 1) and dlength[i] [k] in the program (indicated in FIG. 5) both represent the distance between two cities. The storage area for the value of dlength[i] [k] requires an area equivalent to data that is the square of point_num (the number of cities). In contrast therewith, in the case of the process for computing dlength[i] [k], the storage area requires an area equivalent to the (x, y) coordinate data for point_num cities (i.e., (2×point_num) amount of data).

As mentioned above, according to the associated processes, the storage area can be reduced, thus providing the effect of being able to reduce the communication amount for communication between the local machine and the server 120.

### Annealing Process 5 in Example 1

In the server 120, the data expansion unit 121 receives information transmitted by the local machine (step S131 in FIG. 8), and determines whether or not the received information is represented by a QUBO model (step S132). In the case in which the received information is not represented by a QUBO model (NO in step S132), the received information is represented by a program.

In the case in which the information is represented by a QUBO model (YES in step S132), the data expansion unit 121 outputs the received information to the annealing engine 122. In the case in which the information is represented by a program (NO in step S132), the data expansion unit 121 converts the received information to a format represented by a QUBO model based on the received information (step S134). The data expansion unit 121 outputs the prepared QUBO model to the annealing engine 122.

The annealing engine 122 receives the QUBO model that is input and uses the input QUBO model to perform an annealing process (step S133). That is, the annealing engine 122 computes information representing the solution to the problem represented by the QUBO model. The server 120 transmits the information computed by the annealing engine 122 to the local machine. That is, the server 120 can receive the QUBO model and the program. Thus, according to the associated process in the server 120, the local machine provides the effect of allowing a process for selecting data transmitted to the server 120.

Next, the effects relating to the information processing system 101 according to the first embodiment of the present invention will be explained.

According to the information processing system 101 of the first embodiment, services can be received within a practical time period.

The reason for this is because, in the information processing system 101, the data amount that is transmitted is less than that of the devices disclosed in Patent Document 1, etc. The reason for this will be explained. The devices disclosed in Patent Document 1, etc. transmit Ising and QUBO models corresponding to the source programs to the servers. In contrast therewith, the local machine according to the present embodiment converts processes equivalent to the source program S to a program with a small data amount, and transmits the program, or Ising and QUBO models corresponding to the converted program, to the server 120. As a result thereof, according to the information processing system 101 of the first embodiment, services can be received within a practical time period, even in the case in which the scale of the problem is large.

For example, the device disclosed in Patent Document 1 would transmit 90,000 (=300×300) bits of data to the server in a traveling salesman problem with 300 cities. For example, in the case in which the connection density between cities is approximately 1.3%, the data amount of the QUBO model would be approximately 200 MB (megabytes).

In contrast therewith, in the case of the information processing system 101 according to the present embodiment, the data amount for representing the (x, y) coordinates representing the locations of the 300 cities is 2.4 K (kilo) bytes (=4B×2×300). The data amount of the distance calculation program is merely about 10 KB. In this case, the information processing system 101 according to the present embodiment would communicate 15 KB of data.

Therefore, according to the information processing system 101 of the first embodiment, the transmitted data amount is small. Thus, even in the case in which the scale of a problem is large, services can be received within a practical time period.

### Example 2: Shift Optimization Problem

The shift optimization problem is a problem of preparing a schedule, for example, of work shifts for nurses to work at a hospital. Scheduling for preparing optimal work shifts is an example of a combinatorial optimization problem.

### Spin Assignment Process 2 in Example 2 and Formulation Process 3 in Example 2

In the shift optimization problem, there are, for example, constraint 3 to constraint 6 below.

(Constraint 3) Five or more nurses work each day.
(Constraint 4) The number of work days is averaged.
(Constraint 5) Among the nurses working, at least one is of manager class.
(Constraint 6) The nurses may not work three times in a row.

Constraint 3 to Constraint 6 can also be represented using mathematical expressions representing Hamiltonians, as with Constraint 1 and Constraint 2 mentioned above. For example, Constraint 6 can be expressed as in Expression 6 below.

H=Σₘ₌₀²⁰(Σ_{d=0}³⁰⁻²X_{md}X_{md+1}X_{md+2}) (Expression 6)

In this case, m (a natural number satisfying the condition 0≤m≤20) represents a nurse identifier. Suppose that there are 21 nurses. d (a natural number satisfying the condition 0≤d≤28 (=30−2)) represents one day from day 1 to day 31. Since the right side of Expression 6 includes the parameters (d) to (d+2), in the case in which 0≤d≤28, said parameters represent any value from 0 to 30 (i.e., corresponding to 31 days). X_{md} represents spin. In the case in which the value of X_{md} is 0, this indicates that nurse m has day d off. In the case in which the value of X_{md} is 1, this indicates that nurse m is working on day d.

Expression 6 is a cubic equation in terms of spin. However, the QUBO model can only handle up to quadratic equations in terms of spin. Therefore, an auxiliary spin Y_{md} such as “Y_{md}=X_{md}*X_{md+1}” is introduced. In this case, Expression 6 can be modified to Expression 7 below.

H=Σₘ₌₀²⁰(Σ_{d=0}³⁰⁻²Y_{md}X_{md+2}) (Expression 7)

That is, Expression 7 is a quadratic equation in terms of spin.

However, in this case, the number of spins increases. In other words, a Hamiltonian Hp (indicated by Expression 8) representing the constraint “Y_{md}=X_{md}*X_{md+1}” is required.

Hp=X_{md}X_{md+1}−2X_{md}Y_{md}−2X_{md+1}Y_{md}+3Y_{md} (Expression 8)

In other words, Expression 8 is a mathematical expression representing a constraint used for representing the process associated with the Hamiltonian indicated by Expression 6 in a QUBO model. However, the manner of representing the auxiliary spins and the mathematical expression representing the constraint on the auxiliary spins is not limited to the example mentioned above.

For example, in the case in which a program includes a command (or a rule) for defining auxiliary spins, a determination can be made by using said command (or rule). The process for determining whether or not a program includes auxiliary spins may, for example, be realized by a process for determining whether or not a constraint as indicated by Expression 8 is included. Alternatively, the process of determining whether or not the program includes auxiliary spins may involve making the determination in accordance with whether or not said program includes a process for computing spins by taking the product of at least two spins and a process for computing a Hamiltonian by using the processing results thereof (indicated by Expression 8).

Alternatively, it can also be determined whether or not a program includes auxiliary spins by a process of substituting values into auxiliary spins. The determination process may be realized, for example, by setting each of X_{md}, X_{md+1}, and Y_{md} in Expression 8 to 0 or 1, then computing the energy of the constraint “Y_{md}=X_{md}*X_{md+1}” (for example, the difference between the two sides), and determining that the energy is 0 only when the constraint “Y_{md}=X_{md}*X_{md+1}” is satisfied, and otherwise determining that the value is 1 or more.

The determination process regarding whether or not the program includes auxiliary spins is not limited to the abovementioned example.

### Model Preparation Process 4 in Example 2

The processes in the information processing system 101 according to the first embodiment in the case of Example 2 will be explained with reference to FIG. 7.

The processes from step S111 to step S113 and step S117 are similar to the above-mentioned processes in Example 1. Thus, the explanations of step S111 to step S113 and step S117 will be omitted.

In Example 2, the Hamiltonian (indicated by Expression 7 and Expression 8) includes parameters representing auxiliary spins. In this case (YES in step S113), the formula decomposition unit 111 prepares a Hamiltonian that is equivalent to said Hamiltonian, wherein the Hamiltonian (indicated by Expression 6) does not include auxiliary spins (or has fewer auxiliary spins than the Hamiltonian that was input) (step S118). The formula decomposition unit 111 transmits the data for a program written using the prepared Hamiltonian (indicated by Expression 6) to the server 120.

Compared with the case in which the Hamiltonian includes auxiliary spins, the amount of writing in the program is reduced for the case in which the Hamiltonian does not include auxiliary spins. Thus, according to the above-mentioned process, the effect of being able to reduce the communication amount for communication between the local machine and the server 120 is obtained.

In the case in which a program representing a Hamiltonian including a cubic or a higher term relating to spin is received, the server 120 prepares a Hamiltonian equivalent to said Hamiltonian, the Hamiltonian including only quadratic or lower terms relating to spin. In Example 2, the server 120, for example, uses auxiliary spins to prepare a program representing the processes in the Hamiltonian exemplified in Expression 7 and Expression 8 (step S118).

In the local machine, the data format determination unit 112 generates a QUBO model representing the processes in the Hamiltonian. The data format determination unit 112 compresses the prepared QUBO model (step S115 and step S119).

The data format determination unit 112 compares the data amount of the QUBO model after compression with the data amount of the program representing the processes in the Hamiltonian including auxiliary spins (step S116). In the case in which the data amount of the program is equal to or greater than the data amount of the QUBO model (NO in step S116), the data format determination unit 112 transmits the QUBO model to the server 120 (step S120). In the case in which the data amount of the QUBO model is greater than the data amount of the program (YES in step S116), the data format determination unit 112 executes the process indicated in step S121.

Since the matrix in the above-mentioned QUBO model cannot be decomposed into a program for computing the matrix and data which is the basis for computing the matrix (NO in step S121), the data format determination unit 112 transmits a program to the server 120 (step S123).

Thereafter, the server 120 executes the process indicated in FIG. 8.

The effects of the information processing device 110 and the information processing system 101 in Example 2 will be explained.

For example, in order to prepare a work shift table spanning 30 days in 1 H (hour) units for 50 people (the average number of nurses per hundred beds is reported to be 52.3 in the reference document “Summary of 2017 Medical Facility (Static/Dynamic) Investigation/Hospital Report”), a minimum of 50×24×30=36,000 bits is required. Even in business types with work shifts, such as hospitals, security guards, convenience stores, etc., services can be received within a practical time period by means of the information processing device 110 and the information processing system 101 according to the present embodiment.

### Second Embodiment

Next, a second embodiment of the present invention, which is the basis of the first embodiment, will be explained.

The configuration of the information processing device 200 according to the second embodiment of the present invention will be explained in detail with reference to FIG. 9. FIG. 9 is a block diagram depicting the configuration of the information processing device 200 according to the second embodiment of the present invention.

The information processing device 200 according to the second embodiment has a data format determination unit 201.

The information processing device 200 is communicably connected to a server over a communication network. The information processing device 200 and the server may be connected by a transmission line.

The server can provide services for solving combinatorial optimization problems based on a minimum energy search calculation method, and has an annealing engine for realizing the operations of the services.

Next, the processes in the information processing device 200 according to the second embodiment of the present invention will be explained in detail with reference to FIG. 10. FIG. 10 is a flow chart depicting the flow of processes in the information processing device 200 according to the second embodiment.

The data format determination unit 201 compares the data amount of a QUBO model that is to be processed by the annealing engine with the data amount of a program representing the QUBO model (step S201). The QUBO model and the program are as described above regarding the first embodiment.

The data format determination unit 201 transmits the QUBO model or the program, whichever has a lower data amount, to the server having the annealing engine (step S202). The server receives the information transmitted by the data format determination unit 201, and outputs the received information to the annealing engine. The annealing engine operates in accordance with the input information. That is, the annealing engine computes a solution to a combinatorial optimization problem based on a minimum energy search calculation method.

The data format determination unit 201 according to the second embodiment can be realized by using functions similar to the functions of the data format determination unit 112 (FIG. 1) according to the first embodiment. Therefore, the information processing device 200 according to the second embodiment can be realized by using functions similar to the functions of the information processing device 110 (FIG. 1) according to the first embodiment. The data format determination unit 201 according to the second embodiment may, for example, have functions similar to the functions of the formula decomposition unit 111 (FIG. 1) according to the first embodiment and the functions of the data set preparation unit 113 (FIG. 1).

Next, the effects relating to the information processing device 200 according to the second embodiment of the present invention will be explained.

According to the information processing device 200 of the present embodiment, provided services can be received within a practical time period. The reason for this is because, of the QUBO model and the program, whichever has a lower data amount is selected and transmitted to the server.

### Hardware Configuration Example

An example of the configuration of hardware resources for realizing the information processing system, the information processing device, and the server according to the respective embodiments of the present invention described above by using a single computational processing device (information processing device, computer) will be explained. However, the information processing system, the information processing device, and the server may also be realized by physically or functionally using at least two computational processing devices. Additionally, the information processing system, the information processing device, and the server may be realized as dedicated devices.

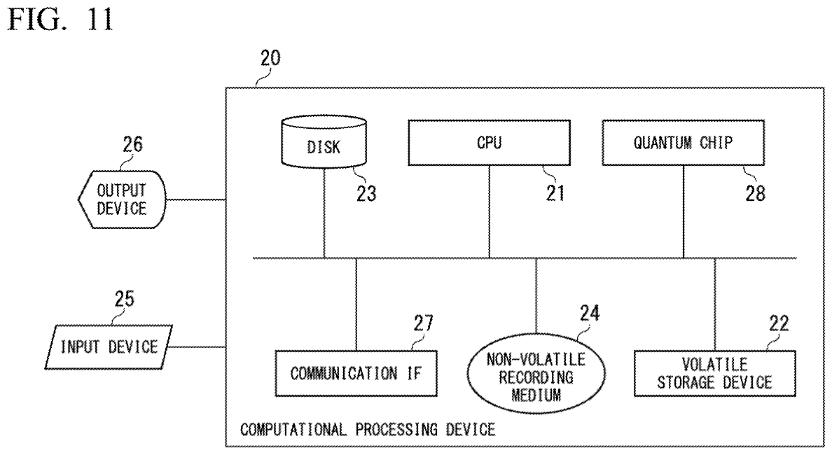

FIG. 11 is a block diagram schematically depicting an example of the hardware configuration of a computational processing device by which an information processing system, an information processing device, and a server according to the respective embodiments of the present invention can be realized. The computational processing device 20 has a central processing device (Central Processing Unit, hereinafter referred to as “CPU”) 21, a volatile storage device 22, a disk 23, a non-volatile recording medium 24, and a communication interface (hereinafter referred to as “communication IF”) 27. The computational processing device 20 may have a quantum chip 28. The computational processing device 20 may be connected to an input device 25 and an output device 26. The computational processing device 20 can exchange information with other computational processing devices and with the communication device via the communication IF 27.

The non-volatile recording medium 24 is a recording medium that can be read by a computer, for example, a compact disc or a digital versatile disc. Additionally, the non-volatile recording medium 24 may be a universal serial bus memory (USB memory), a solid state drive, etc. The non-volatile recording medium 24 retains the program even when power is not supplied, and is portable. The non-volatile recording medium 24 is not limited to the media mentioned above. Additionally, instead of the non-volatile recording medium 24, the program may be made portable over the communication IF 27 and the communication network.

The volatile storage device 22 can be read by a computer and is able to temporarily store data. The volatile storage device 22 is a memory or the like such as DRAM (dynamic random access memory) or SRAM (static random access memory).

That is, the CPU 21 copies a software program (computer program, hereinafter referred to simply as a “program”) that is stored on the disk 23 to the volatile storage device 22 at the time of execution, and executes computational processes. The CPU 21 reads data which is required for executing the program from the volatile storage device 22. In the case in which display is required, the CPU 21 displays output results on the output device 26. When the program is input from an external source, the CPU 21 reads the program from the input device 25.

The quantum chip 28 is a chip that operates by using quantum states in quantum mechanics. The quantum chip 28 operates as described above for the annealing engine. The operations in the annealing engine may be performed by the quantum chip 28 or may be performed by the CPU 21.

The CPU 21 interprets and executes an information processing program (FIG. 2, FIG. 7, FIG. 8, or FIG. 10) in the volatile storage device 22, which corresponds to functions (processes) represented by the respective units indicated in FIG. 1 or FIG. 9 above. The CPU 21 executes the processes explained for the respective embodiments of the present invention described above.

That is, in such cases, the respective embodiments of the present invention can be understood as being implementable by the information processing program. Furthermore, the information processing program can be understood as also being able to implement the respective embodiments of the present invention by means of the non-volatile recording medium, which can be read by a computer in which the information processing program is recorded.

The present invention has been explained with the above-described embodiments as exemplary cases. However, the present invention is not limited to the embodiments described above. That is, various embodiments that could be understood by a person skilled in the art can be applied within the scope of the present invention.

The present application claims priority on the basis of Japanese Patent Application No. 2020-159139, filed Sep. 23, 2020, the entire disclosure of which is incorporated herein by reference.

### INDUSTRIAL APPLICABILITY

The present invention can be applied, for example, to the provision of services using a communication network.

### REFERENCE SIGNS LIST

101 Information processing system
110 Information processing device
111 Formula decomposition unit (formula decomposing means)
112 Data format determination unit
113 Data set preparation unit
151 Communication network
120 Server
121 Data expansion unit
122 Annealing engine
200 Information processing device
201 Data format determination unit (data format determining means)
20 Computational processing device
21 CPU
22 Volatile storage device
23 Disk
24 Non-volatile recording medium
25 Input device
26 Output device
27 Communication IF
28 Quantum chip

What is claimed is:

1. An information processing device comprising:
at least one memory configured to store instructions, and
at least one processor configured to execute the instructions to:
compare a data amount of a QUBO model to be processed by an annealing engine and a data amount of a program representing the QUBO model; and
transmit whichever has a lower data amount to the annealing engine.

2. The information processing device according to claim 1,
wherein the at least one processor is further configured to execute the instructions to:
extract, from the program, a Hamiltonian among processes to be performed in the annealing engine;
convert the extracted Hamiltonian to a Hamiltonian with a lower data amount by mathematical formula manipulation; and
convert a process represented by the converted Hamiltonian to a program.

3. The information processing device according to claim 2,
wherein the at least one processor is configured to execute the instructions to:
convert the process represented by the Hamiltonian to the program by using a condition that a square of a quantum bit is equal to said quantum bit.

4. The information processing device according to claim 2,
wherein the at least one processor is configured to execute the instructions to:
convert, in a case in which a process for computing the Hamiltonian is described by an iterative process in the program, the iterative process to a function representing a process equivalent to said iterative process.

5. The information processing device according to claim 2,
wherein the at least one processor is configured to execute the instructions to:
convert, in a case in which the Hamiltonian in the program includes second spin introduced such that a product of three or more spins becomes a product of two or fewer spins, the program to a second program not including the second spin.

6. The information processing device according to claim 1,
wherein the at least one processor is configured to execute the instructions to:
determine whether or not a matrix representing the QUBO model satisfies a criterion for determining whether to execute a compression process on the matrix; and
convert, if the matrix satisfies the criterion, the matrix to information represented in a prescribed compression format.

7. An information processing system comprising:
an information processing device; and
an annealing engine,
wherein the information processing device comprises:
at least one memory configured to store instructions, and
at least one processor configured to execute the instructions to:
compare a data amount of a QUBO model to be processed by the annealing engine and a data amount of a program representing the QUBO model; and
transmit whichever has a lower data amount to the annealing engine.

8. An information processing method comprising:
comparing a data amount of a QUBO model to be processed by an annealing engine and a data amount of a program representing the QUBO model; and
transmitting whichever has a lower data amount to the annealing engine.

9. (canceled)
